(19) United States
(12) Patent Application Publication
(10) Pub. No.: US 2018/0145840 A1
(43) Pub. Date: May 24, 2018

(54) INTEGRATION OF INTERNET-BASED TOOLS FOR TRANSFORMING IN-PERSON CONFERENCES INTO SEAMLESS CONVERSATIONS

(71) Applicant: DialogLoop Inc., Calgary (CA)

(72) Inventors: Dinesh Advani, Calgary (CA); Emmanuel Gueritte, Paris (FR)

(21) Appl. No.: 15/635,586

(22) Filed: Jun. 28, 2017

Related U.S. Application Data
(60) Provisional application No. 62/356,232, filed on Jun. 29, 2016.

(51) Int. Cl. H04L 12/18; H04L 29/08

(52) U.S. Cl. CPC H04L 12/1822; H04L 67/20; H04L 67/06; H04L 67/02; H04L 12/1831

(57) ABSTRACT

Multiple schemes and techniques for enhancing slide content sharing during presentations, engaging audience participation, and facilitating social networking through digital devices within in-person conferences are described. For example, Internet-enabled digital devices used by persons attending presentations are used to establish dialog loops with presenters and other attendees or remote participants. The dialog loops allow seamless sharing of slides, Q&A sessions, instantaneous surveys and the establishment of connections between people that may be unknown to each other in the conference space thereby facilitating more meaningful business or professional experiences in these settings.

### CROSS-REFERENCE TO RELATED APPLICATIONS

This application claims the benefit of priority of U.S. Provisional Application No. 62/356,232 filed Jun. 29, 2016, which is incorporated herein by reference.

### BACKGROUND OF THE INVENTION

### (1) Field of the Invention

The present invention relates to corporate and professional in-person conferences or other face-to-face meetings wherein groups of people with common interests gather to hear presentations, see demonstrations, and discuss topics of mutual interest. More specifically, the technical field relates to the use of Internet-based software and Internet-enabled digital devices to enhance the commercial value of aforesaid meetings by providing presentation content sharing, tools for real-time presentation engagement, and enhanced social networking in a seamless manner to participants.

### (2) Description of the Related Art

In-person meetings between business and professional people are a large and growing economic segment of the world economy. In the US, a 2012 report by PricewaterhouseCoopers showed that there were over 270,000 conferences with an excess of 60 million participants in that year alone with an economic value of around $75 Billion.

In spite of their economic importance and the fact that the costs to the attendees is typically between $1,000 to $5000 per meeting, there have not been many advances to improve the delivery of content sharing, presentation engagement, and attendee networking. Indeed, the rapid growth of online conferences (without in-person contact) in the form of webinars that have emerged since the advent of the Internet is partly a result of the ineffectiveness of such events in achieving positive cost/benefit results for attendees and their organizations.

People generally pay money to attend these events for two main reasons—to learn and meet people for personal and organizational betterment. Operationally, this means that the conference must function to provide excellence in information sharing, intellectual engagement of all participants during presentations, and networking opportunities throughout the event. The table below shows a summary of the present state-of-the-art quality of in-person conferences along these metrics for the lifetime of a conference event. Pre-conference activities by organizers usually do not provide much value to registrants in any of these three metrics. Moreover, during the conference it can be seen from this table that content sharing, audience engagement, and networking activities are generally not matching the needs of attendees who are being shaped by advanced digital communication technologies in all of these areas in other parts of their lives.

A key aspect of these events is that knowledge-seeking individuals are attempting to interact within physical spaces that contain large numbers of strangers and this naturally leads to difficulties in personal communication. For example, within presentation rooms, speakers generally conduct mostly one-way dissemination of knowledge through slide projections onto screens with limited interaction with the audience. The attendees don't usually have access to the slides during the presentation. Notes on the presentation are generally handwritten on paper or entered into other digital devices. The presenter's words are typically not recorded for later review by attendees. Q&A sessions tend to be brief and at the end of the presentation, with only a very few attendees able to interact with the presenter. There is also almost no interaction between members of the audience unless they are sitting next to each other. Lastly, the presenter never really knows who most of his audience is and what they really thought about the various slides and his presentation.

The situation becomes even more problematic away from the presentation rooms as the randomness of individual interactions in various physical venues takes over the bulk of the networking time. For example, how can an individual figure out which of say 400 people to connect with in a crowded dinner hall without some prior knowledge of these people or referrals from acquaintances? The social networking strategy of most attendees is usually not optimal. It tends toward two extremes—(1) hand out as many business cards as possible, or (2) have conversations with several people that are interesting and knowledgeable.

In summary the content sharing, engagement and networking activities presently occurring at in-person conferences need improvement in order to justify the ever-increasing costs of these events and meet the needs of attendees wishing to maximize economic value.

### BRIEF SUMMARY OF THE INVENTION

Certain aspects of embodiments disclosed herein by way of example are summarized below. It should be understood that these aspects are presented merely to provide the reader with a brief summary of certain forms an invention disclosed and/or claimed herein might take and that these aspects are not intended to limit the scope of any invention disclosed and/or claimed herein. Indeed, any invention disclosed and/or claimed herein may encompass a variety of aspects that may not be set forth below.

The present disclosure generally relates to techniques for transforming in-person conferences into seamless conversations among participants through the use of Internet-enhanced digital methods and systems. The issues in the present state-of-the-art in-person conference environments previously noted are addressed by providing solutions for content sharing and engagement through novel software that builds on existing slide presentation platforms in common use today such as Microsoft PowerPoint and Apple Keynote. The disclosure also addresses the social networking issues with a novel software platform that intelligently identifies common links in the digital social network databases of each attendee from their LinkedIn, Facebook, and Twitter accounts to provide lists of names and attributes of potential high value connections to be made with other attendees at the conference. A brief summary of the capabilities of the novel software is shown in the table below.

For pre-conference networking the present invention provides digital software and hardware systems that integrate the existing digital social networks of each conference registrant such as on LinkedIn, Facebook, and Twitter to provide recommendations and facilitate the arrangements of meetings and other social events with other conference registrants. In this manner each conference attendee will already have begun valuable networking activities even before setting foot in the conference location. These same methods and systems are extended to encompass both in-conference and post-conference networking activities.

In-conference content sharing is made possible by digital software and hardware systems that allow slide sharing in real-time between presenter and attendees as well as attendee notetaking that is linked to each slide. Attendees are able to send questions through their digital devices to the presenter and also see all the questions submitted by other attendees. These questions can be “Liked” by the audience and thereby rise in priority for reply by the presenter. Moreover, the presenter can send a digital survey to the attendees' devices for reply at any time during the live presentation. Also, through the use of the invention's audio beacon system and method there exists a seamless connectivity of all attendees' devices as they enter and leave the presentation room.

The post-conference advantages of the present invention are numerous and deal directly with the need to enhance value to participants of the conference. For example, a presentation session can remain “Live” on a Web Server and available to both presenter and all attendees of the conference for specified periods of time. This means that both an audio recording of the presentation as well as all the slides and Q&A session are accessible at any time. Further conversations between participants can therefore also occur at this time. A specific social network containing only these specific persons can also be created and maintained if the participants so desire. Lastly, the invention's social networking program code can assist in the maintenance and enhancement of relationships between attendees after the conclusion of the event.

Some aspects of this invention will now be described. The systems of the invention consist of an extensive software code residing on a Web Server that is available from a Cloud Services Provider such as Amazon Web Services. The number of Web Servers and their data handling capacity can be expanded to match the size and growth of the in-person conference activities as required. Portions of the software code that are designed for the Client-side can be downloaded and accessed by presenters and attendees through one of their digital devices such as for example a smartphone running on an Android operating system or an iPhone running on iOS; a Tablet PC running on Windows, Android or iOS; a laptop running on Windows or Mac operating system; and, a desktop computer running on Windows or a Mac Operating System. The Client-side software interacts with the Web Server through Internet communication protocols. The presenters and attendees become connected in a seamless fashion through the software that resides on both the Client-side and Web Server machines.

In one embodiment of the invention a presenter at an in-person conference initiates a PowerPoint presentation on a device and using the Client-side software of this invention is then able to convert this PowerPoint presentation into a different file format that is sent to the aforementioned Web Server and kept there for all future interactions between presenters or attendees in the conference. The Client-side software mentioned above can be a PowerPoint Add-In application constructed using Visual Studio Tools for Office. In another embodiment of the invention the Client-side software is a responsive Web App that allows use of any digital device for communication.

In one embodiment of this invention the devices belonging to the presenter and attendees in a presentation room are equipped with further invention software (DialogBeacon™) that allows seamless communication between themselves using audio signals in the high-end of the frequency range (16 kHz-22 kHz) without the need for the energy-consuming Bluetooth™ technology or iBeacon™ hardware. DialogBeacon™ uses complex digital signal processing software that generates an audio file that encodes data (uniquely identifiable numbers) associated with a presentation session and linked to the devices in use at that location.

The methods and systems briefly described above allow for the seamless digital interaction of Internet-enabled devices via User Interface commands from presenters and attendees in a conference. The following descriptions will further develop the methods of the present invention by considering the features of the software for enhancing presentation content sharing, engagement, and social networking.

### Presentation Content Sharing

From a presenter's perspective each slide from either a PowerPoint or Keynote or other similar program can be shared in real time from the presenter's device to all attendee devices at a presentation location. The presenter allows the attendees to see the slides on their devices in the same order as the presenter projects them (synchronous mode) onto a projector screen located near a wall in the room and attendees are also able to revert back and examine previous slides during the presentation (asynchronous mode) while the presenter moves forward with the presentation in a linear fashion. The ability to operate in both synchronous and asynchronous mode between two digital devices will be termed progressive reveal of slides.

The presenter can also obtain instant feedback from the attendees because of a feature in the software that allows attendees to “Like” a particular slide. These statistics are useful in informing the presenter about how the audience interacted with the content. Presenters are able to control the content that attendees see on their devices by allowing the presenters to delete, update, hide and pin slide content. Presenters are also able to manage all aspects of the content of each presentation including question and answer sessions and surveys. Presenters can also manage the content of the presentation to suit the specific needs of future conferences or events. Also, the presenter may wish to compare and contrast the reaction of attendees in two different conferences or events for a unique slide presentation and associated engagement content. A further feature of the invention is that at any point during a presentation the presenter may assign another person to present a segment of the content. In this case the new presenter has rapid access to content on their own device that allows a seamless handoff.

Another feature of the software is that it allows the presenter to keep the presentation “Live” on the Web Server for any length of time after the end of the presentation. This means that the presenter can go onto the Web Server at any time and make changes to the slides while allowing attendees the ability to also see the presentation at a later time. A further feature of the software is that the presenter can control the forward and backward movement of slides by use of a mobile device or a web browser on a device controlled by the presenter. Lastly, the presenter's words are recorded during a presentation and the resulting audio file (.WAV or AIFF) is stored on a Web Database Server for later retrieval.

By using their devices, the attendees are able to easily and instantly access the slides in a presentation, review past slides as needed, and synchronize (catch up) to the presenters slide with a click of a User Interface button on their devices. Attendees can “Like” slides and takes notes linked to a particular slide which are stored for later retrieval from the Web Server and associated Web Database Server. A reporting feature in the software allows attendees to create a summary of the presentation on their devices.

Conference organizers are able to access the presentation files for each session during the conference and see the level of interest and use for each presentation. Highly popular presentations may be later promoted—similar to a TEDTalk—to increase commercial value of their conferences.

### Engagement During a Presentation

The presenter may at any time during a presentation initiate a digitally-driven Q&A session with the attendees by clicking a button on the User Interface of the invention software running on a Client-side device. The software features methods to prioritize the list of questions submitted by attendees as for example by polling of “Like” responses from anyone in attendance to each of the questions. The questions are viewed instantly by all participants in a presentation and each question is tagged with the attendee's name. The questions are also linked to the slide that was being shown at the time the question was posed in digital format. The presenter may also delete questions from the session at any time.

Presenters may also instantly request a digital survey of all the attendees in the audience at any time during the presentation by clicking a button on the User Interface of the invention software. This survey is automatically pushed to attendee devices for reply. Survey results are summarized in graphs and tables in digital format for viewing by the presenter, organizer, and attendees at any time during or after a conference.

### Social Networking

The invention software provides an audience profile for the presenter during a presentation by means of three views. In the List View the names of all attendees are listed. In the Summary View a listing of the Questions and Survey results is provided. In the Map View the presenter is able to see the activity—attendees entering/leaving the room, number of questions, and other metrics—as a function of time. The invention software also provides the presenter with digital tools to connect with anyone who attended a presentation. Lists of attendees can be imported into PowerPoint and Keynote and then sent to organizers for further evaluation and used by presenter for follow-up at the end of the conference. Also, the presenter can delete the session on the Web Server and Web Database Server at any time after the completion of the presentation.

The invention software allows the attendees to gain insight by having a number of LinkedIn profiles displayed for people in the session. Each attendee is able to see who else is in the room and their digital social networking profile. The attendees are also able to see the presenter's profile and professional background on their devices and the references to the other work done by the presenter.

When attendees and presenters login to the invention software their profiles from LinkedIn, Facebook and Twitter are downloaded to the Web Server Database. The invention software then proceeds to examine these digital profiles to find potential commonalities among the conference participants in order to recommend new in-person connections at the conference.

These and other features, aspects, and advantages of the present invention become better understood when the following detailed description of certain exemplary embodiments is read with reference to the accompanying drawings in which like characters represent like parts throughout the drawings.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 is a block diagram of exemplary components of an in-conference ecosystem in accordance with aspects of the present technique according to an exemplary embodiment;

FIG. 2 is a pictorial representation of how digital social network information is transformed by the invention software to enrich an in-person conversation in accordance with aspects of the present technique according to an exemplary embodiment;

FIG. 3 is a system block diagram according to an exemplary embodiment;

FIG. 4 is a DLPS FlowChart for creating and managing a DialogLoop Session according to an exemplary embodiment;

FIG. 5 illustrates an overview of a host application adapter User Interface according to an exemplary embodiment;

FIG. 6 illustrates an Login/Managing Presenter Profiles according to an exemplary embodiment;

FIG. 7 illustrates a 1110 DialogLoop Space according to an exemplary embodiment;

FIG. 8 illustrates a 1120 Session URL and URL Slide according to an exemplary embodiment;

FIG. 9 illustrates a 1160 DialogLoop Survey System according to an exemplary embodiment;

FIG. 10 illustrates a 1170 DialogLoop Live Questions Slide according to an exemplary embodiment;

FIG. 11 illustrates a 1130 Resources on the DialogLoop Platform according to an exemplary embodiment;

FIG. 12 illustrates a 1300 Multi-media recording and sync-up with content according to an exemplary embodiment;

FIG. 13 illustrates different displays of the DialogLoop Client Application according to an exemplary embodiment;

FIG. 14 illustrates a Display of the People in attendance and organization of networking recommendations according to an exemplary embodiment;

FIG. 15 illustrates a Display of Attendee Questions according to an exemplary embodiment;

FIG. 16 illustrates a Display of Attendee profile and Chat capability according to an exemplary embodiment;

FIG. 17 illustrates a Visual representation of a dialog loop according to an exemplary embodiment;

FIG. 18 illustrates Displays re-injection of real-time information according to an exemplary embodiment; and

FIG. 19 illustrates Displays interaction between the Host Application Adapter and DLPS according to an exemplary embodiment.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The application is generally directed to in-person conference software and hardware that facilitate the sharing of presentation content, engage audiences with presenters, and facilitate the oftentimes random nature of finding high value personal contacts in crowded assemblies of mostly strangers.

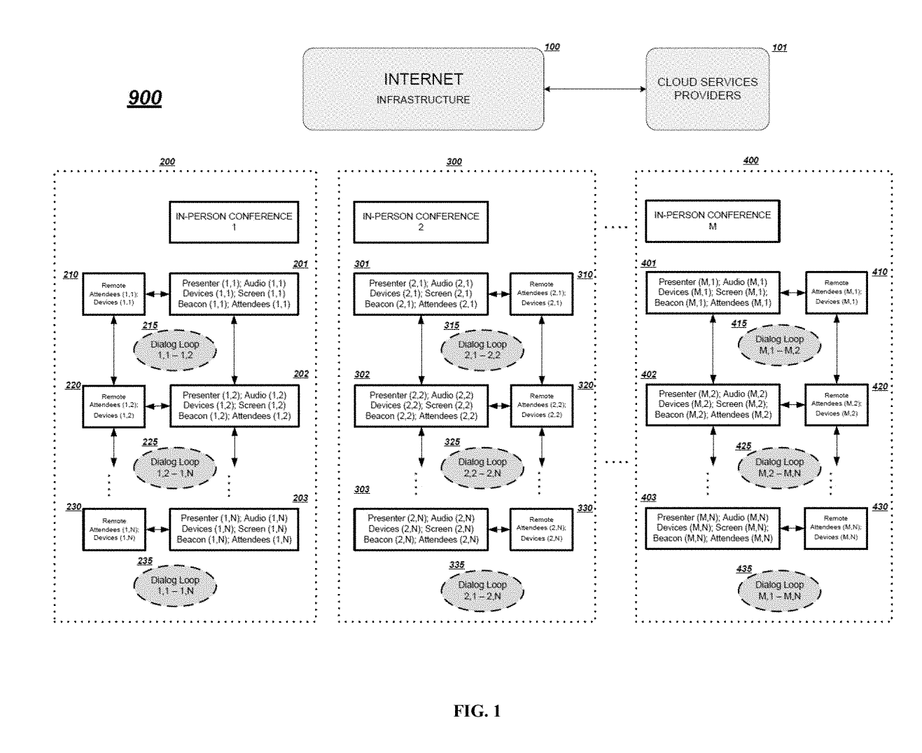

FIG. 1 is a block diagram of exemplary components of an in-person conferencing and social networking system containing digital software and hardware components in accordance with aspects of the present invention.

The system 900 in FIG. 1 is a complex arrangement of multiple In-Person Conferences 200, 300, 400 that are facilitated by interconnection to the worldwide web Internet Infrastructure 100 and Cloud-based service providers 101. Examples of Cloud-based service providers are Amazon Web Services (AWS), Microsoft Azure, and Google Cloud Platform. The In-person Conferences generally take place at various dispersed geographic locations. As indicated in FIG. 1 the methods and systems detailed in this invention are scalable to any number of In-Person Conferences, M, in any physical space configuration by virtue of easily expanded digital hardware and software with the Cloud Services Providers 101. The multiple In-Person Conferences 200, 300, 400 typically occur contemporaneously, in series, or in combination over the course of a calendar year.

The following explanation will focus on In-Person Conference 200 but the details can be applied identically to each of the In-Person Conferences 300, 400 and their associated elements (i.e., 301-303, 310-330; 401-403, 410-430) without any modification. Multiple In-Person Presentations 201, 202, 203 usually occur within specific physical spaces or rooms within In-Person Conference 200. The physical spaces or rooms are occupied among other things by human resources and machines.

The human resources of interest in the example of In-Person Presentation 201 are a Presenter (1,1), Attendees (1,1), and Remote Attendees (1,1) located in a remote location that could either be at In-Person Conference 200 or offsite.

The machines in one embodiment of the present invention are Devices (1,1) that consist of Internet-enabled-connectivity appliances such as smartphones, Tablet PCs, iPads, laptop computers and any other devices that link human resources and machines in 201 and more generally to any In-Person Presentation, N, as for example 202, 203 within the particular In-Person Conference 200. The Devices (1,1) are typically operated by the Presenters, Attendees, and Remote Attendees within the In-Person Conference 200.

A further example of a machine operating within 201 is a Screen (1,1) consisting of a screen projector and its associated large-scale physical screen that can be viewed easily by most Attendees (1,1) within the physical space or room. Another example of machines operating within 201 are Audio (1,1) that consist of a conventional microphone and associated equipment connected to either an amplifier to ensure that Attendees (1.1) can hear Presenter (1,1) or an analog-to-digital conversion machine that converts the Presenter (1,1) words into digital audio signals and sends them in real time to Remote Attendees (1,1). Both routes taken by the audio signals are facilitated by the Internet Infrastructure 100 and Cloud Services Providers 101. The resulting digital audio signals can also be stored in an audio file format such as .WAV and Audio Interchange File Format (.AIFF) on a Web Server of the Cloud Service Provider 101.

Another example of a machine operating within 201 is a novel Beacon (1,1)—commercially known as DialogBeacon™—that emits audio waves at specified intervals according to embodiments of the present invention to be described below and within a prescribed physical distance that includes the physical space or room 201 and that further permits automatic connection and disconnection of the Devices (1,1) as Attendees (1,1) enter and leave the space or room 201. When a Presenter (1,1) links a Device (1,1) through the invention software to the Web Server a session is created. At that time a unique or reused audio signal representing a unique number of, say, an X-bits-long sequence is generated. As an example, the Presentation session 201 may be assigned a session number coded as 7654321 at the Web Server that is assigned an audio WAV file as 7654321.way. This WAV file is very small in size and may have just enough data to play for a few seconds in the frequency range of 16 kHz-22 kHz noted above. When Presenter (1,1) logs in to the Web Server this WAV file is downloaded onto Presenter (1,1)'s internet-connected device. The invention software on the presenter's Client-side device previously described then plays this sound repeatedly through the speakers or headphone jack of the Device (1,1) and amplified into the room's Public Announcement (PA) system. For an Attendee (1,1)'s device to recognize the audio signal from Beacon (1,1) in the room the Attendee (1,1) would have had to give permission to the invention Client-side software application to be able to use the Device (1,1)'s microphone. In this way the Attendee's Client-side Device (1,1) application listens for the signal and does signal processing to determine the number 7654321 which is the assigned session number for the Presentation 201. The Attendee (1,1) is then alerted by the Client-side software and given the option to connect digitally to the presentation occurring in the room. It is emphasised that the Beacon (1,1) signal is sent to the room as long as the Presenter (1,1) is connected to the Web Server session. Because of this fact all the devices belonging to Attendees (1,1) moving in and out of the Presentation room 201 can sign-in and sign-out seamlessly without the need to deal with typing Codes or URLs that are required by state-of-the-art beacon technology today. Also, the length of time for connection and disconnection through the Beacon (1,1) is typically a few seconds. Lastly, Audio Signal Hopping that is briefly described below may be implemented with Beacon (1,1) that does not require a PA system in the Presentation room 201. In this case the method would involve one of the Attendee's (1,1) Devices (1,1) located near the Presenter's (1,1) Device (1,1) listening for the continuous audio signal file and retransmitting this audio file out from Attendee (1,1) own Device (1,1) speakers thereby enabling other Attendees' devices further away from the Presenter (1,1) to connect to the digital session.

The Remote Attendees (1,1) also possess similar Devices (1,1) and can thereby connect to 201 via regular audio signals emitted from the Presenter (1,1) microphone from the In-Person Presentation 201 and can thereby hear the words spoken by the Presenter (1,1) in real-time. Remote Attendees (1,1) also connect to 201 by means of methods and systems of the present invention wherein they are able to view the Screen (1,1) on their Devices (1,1).

Members of any Remote Attendees element in FIG. 1 such as 210, 220, and 230 have the ability to participate in any In-Person Presentation 201, 202 or 203 during and after the live event so long as a digital, web-enabled session associated with the presentation is still active using the methods and systems of the present invention.

Similarly persons within any Attendees' element within In-Person Presentations 201, 202, and 203 have the ability to participate in any In-Person Presentation 201, 202 or 203 during and after the live event so long as a digital, web-enabled session associated with the presentation is still active using the methods and systems of the present invention.

The digital communications network established between elements 201, 210, 202, 220 within In-Person Conference 200 create what is termed a Dialog Loop (1,1-1,2) 215 in which Presenters, Attendees, and Remote Attendees can share content, enhance engagement within the presentations, and facilitate social networking. Any number of Dialog Loops can form during an In-Person Conference in proportion to the number of In-Person Presentations, N. For example, another possible Dialog Loop (1,1)-(1,N) 235 shown in FIG. 1 consists of Remote Attendees 210, 230 and In-Person Presentations 201 and 203.

Furthermore according to one embodiment of the present invention the Remote Attendees 210, 220, 230 can connect to In-Person Presentations 201, 202, and 203 at any time and participate in each of these events by listening to audio and view slides on their Internet-enabled appliances similar to Devices (1,1) as shown in FIG. 1 by bidirectional arrows connecting for example 210, 201, 220, 202.

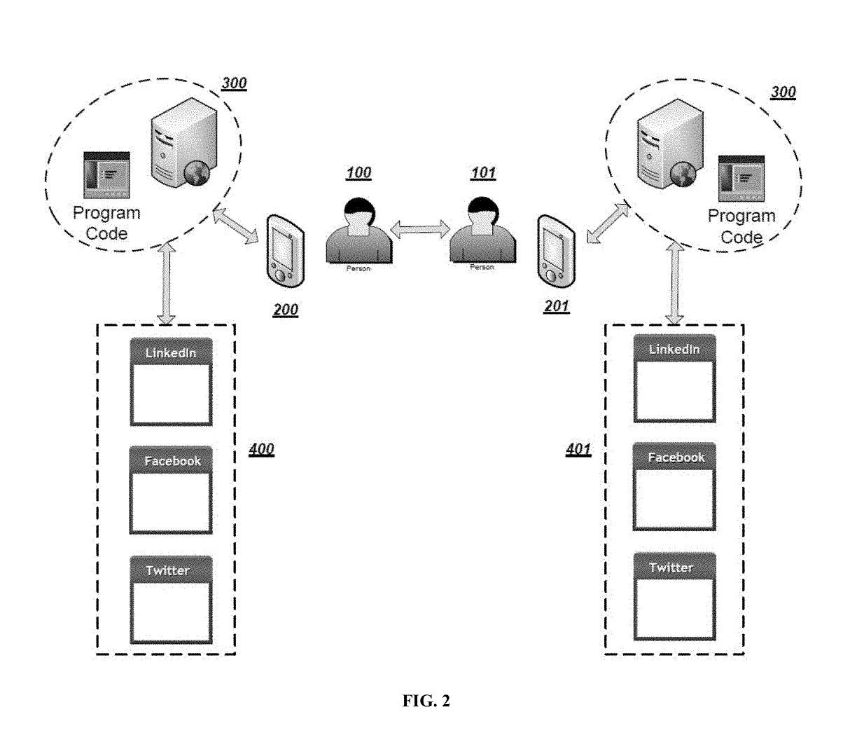

FIG. 2 shows how Internet-connected software and hardware associated with this invention can be used to facilitate an in-person meeting among strangers within an in-person conference. Attendees 100 and 101 are initially unknown to one another. As Attendee 100 initially logs into the Web Server 300 by means of Device 200 that connects into a Presentation session as described in FIG. 1, the program code of this invention located on the Web Server 300 is able to retrieve the digital social networking data contained the Attendee's accounts 400 with LinkedIn, Facebook, and Twitter. Similarly, as Attendee 101 initially logs into the Web Server 300 by means of Device 201 that connects into a Presentation session as described in FIG. 1, the program code of this invention located on the Web Server 300 is similarly able to retrieve the digital social networking data contained digital in the LinkedIn, Facebook, and Twitter accounts 401 of Attendee 101. The Program Code associated with Web Server in 300 is also able to analyze the data in the social network databases 400 and 401 such that social and business information that is common to each person is used to arrive at a decision as to recommend or not recommend a meeting of these two attendees at the conference for the purpose of beginning a dialog on potential business or professional topics. The recommendations sent to each of Attendees 100, 101 gives an explanation for why a potential meeting would be advantageous but leaves each person with the option of accepting or rejecting the meeting. In the case where the Attendees agree to meet, the Program Code records this acceptance and then monitors the digital communication between them over a time period beyond the conclusion of the In-Person Conference.

“A dialog loop” is a process of sharing knowledge with the intention to initiate a group discussion where ideas, feedback, questions and answers can flow freely, fueling the creation of new ideas and generating the motivation to share more, creating an evolving dialog loop.

FIG. 17—Is a visual representation of a dialog loop.

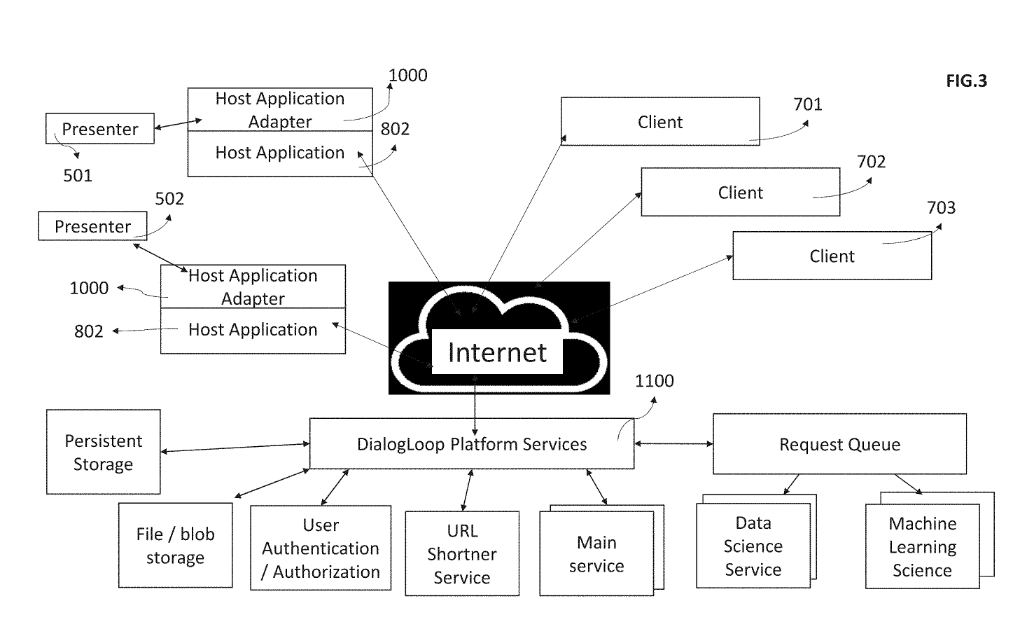

FIG. 3 shows the detailed block diagram of a system for enabling a dialog loop between a presenter who is presenting at an in-person conference presentation/session to attendees with client devices 701, 702 and 703 who are sitting in the audience. The computing device powering the presentation has pre-installed presentation software 802 one example of such a program is Microsoft PowerPoint running on Microsoft Windows. The presentation software 802 is DialogLoop ready as it has the DialogLoop Host Application Adapters 1000 (for example DialogLoop Add-In for Microsoft PowerPoint) pre-installed. The presenter has already logged into the DialogLoop Platform Service 1100 using his social media login such as LinkedIn and is authenticated to make use of the functionality offered by the DialogLoop Platform Services (DLPS).

The system includes:
a) A Host application adapter 1000—which is a new piece of software that is capable of running within or alongside a host application (e.g. DialogLoop Add-in for Microsoft PowerPoint). It is typically, platform specific and is the liaison between the host application (e.g. Microsoft PowerPoint) and the DialogLoop Platform Service (DLPS). This Adapter has knowledge of and can make use of the capabilities of the host application and that of DialogLoop Platform Service. For example, the PowerPoint Add-In understands and can make use of PowerPoint's object model, PowerPoint presentation file format and has access to Microsoft Office API when required. The reader is advised that this document uses “PowerPoint Add-In” and “Host Application Adapter” interchangeably. All inventions/ideas/concepts for Microsoft PowerPoint Add-In also apply to other Host Application Adapter including but not limited to Apple Keynote, Adobe Acrobat, Microsoft Word and more. Statement 1500 provides details on the DialogLoop Host Application Adapter.
b) DialogLoop Platform Services (1100)—enable dialog loops as defined above via API end points to the users. These users may be required to be authenticated before they are allowed access to the services. Users are able to sign-in using multiple methods including but not limited to using their social media accounts, registering for a DialogLoop account and/or using credentials or an access code offered by a third party including the presenter and/or event organizer. The DialogLoop platform services relies on multiple micro-services built on top of scalable Compute, Messaging and Communications, Databases and File Storage services provided by cloud infrastructure provider such as Azure, AWS, Google and others. The information stored on the server maybe encrypted or unencrypted depending on the situation. Statement 1100 DialogLoop Platform Services provides details on the DialogLoop Platform Services. DialogLoop Platform Services is also referred to as DLPS in this document.
c) Plurality of client devices 701-703 operated by attendees and/or presenters coupled to DialogLoop Platform Services by the internet. The clients access the DialogLoop Platform Services in multiple ways including but not limited to the DialogLoop Web App running inside the Web Browsers on their devices 701-703 or Custom Applications provided by DialogLoop or other 3^{rd} party providers including event applications that want to extend their functionality by integrating with DialogLoop Platform Services 1100. Statement 1700 DialogLoop Clients provides details on client devices requiring access to DialogLoop Platform Services.

The reader is advised the ideas/concepts/inventions described for “DialogLoop Add-In for PowerPoint” also apply to other “Host Application Adapters” as described in 1500 DialogLoop Host Application Adapter.

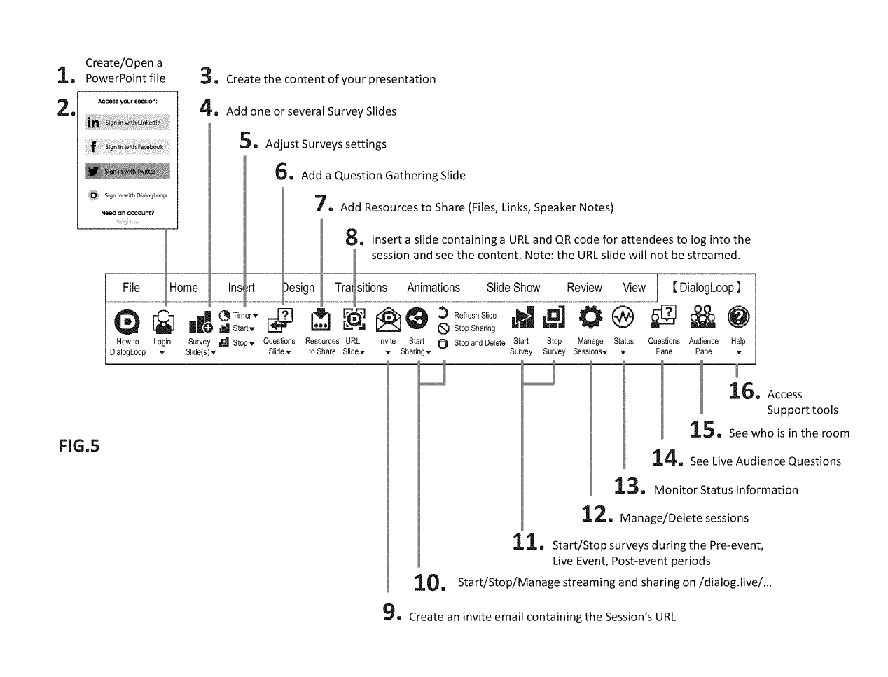

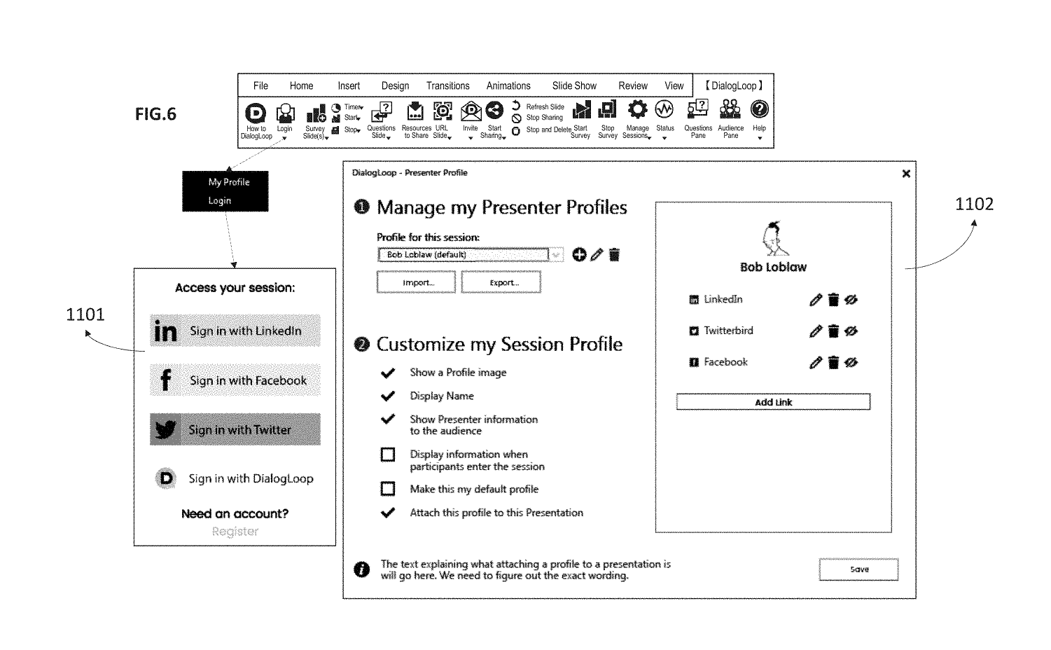

When the host application adapter is installed and authenticated by the DialogLoop Platform Services it exposes new capabilities to the host application. E.g. The DialogLoop Add-In for Microsoft PowerPoint adds a new Ribbon Toolbar FIG. 5. This user interface gives an overview of the new capabilities available to the presenter instantly. It allows the presenter to seamlessly integrate DialogLoop Platform Services directly into the host application to:
1) Get authenticated with the DLPS by logging in. Once authenticated each user receives an access token that is required for further communication with the DLS. This token determines the capabilities of the logged in user and allows them to access DLPS for a limited time. 1101 on FIG. 6 displays one example of how DialogLoop users log into DLPS.
2) The presenter is now able to opens a file in the Host Application (e.g. opening a filename.pptx inside PowerPoint) and without any preparation, is then able to share/stream the slides to the audience in real-time just by using the “Start Sharing” functionality. These slides are progressively revealed to the attendees as the presenter switches the slides.
3) The Host Application Adapter (1000) (e.g. DialogLoop Add-In for PowerPoint) understands both the Host Application (PowerPoint) and the DLPS capabilities and can seamlessly coordinate. See 1100 for the capabilities of DLPS
4) Before the Host Application Adapter does any work it ensures that the document is in a safe and stable state (and forces presenters to save state if required).
5) The first step is to create a new DialogLoop session on behalf of the Host Application. For this purpose, the adaptor uses the capabilities of the host application e.g. PowerPoint to extract the characteristics of the document being shared (e.g. the PowerPoint presentation) on which the presenter is interested in creating a dialog loop. Information extracted could include the title, description, presenter information, preview to display, and which DialogLoop Space to share/stream the content (1110 DialogLoop Space).
6) It enumerates the titles, text on the slides and the layout information, packaging it up along with any other metadata to create searchable and/or language translatable content on the DialogLoop platform (1400 Live simultaneous multi-language Slide, Automatic Slide Translations and Closed Captioning.)
7) It also gathers the content that the presenter would like to share with the participants including resources like files, links and notes.
8) Advanced features may also be configured at this time or at any time during the life of the session. This may influence how the session is configured and how the attendees experience the DialogLoop Session. Some examples include but not limited to:
   a. 1102 Presenter Profile Cards
   b. 1110 DialogLoop Space
   c. 1120 Session URL and URL Slide
   d. 1130 Resources on the DialogLoop Platform
   e. 1400 Live simultaneous multi-language Slide, Automatic Slide Translations and Closed Captioning
   f. who has access to this DialogLoop Session,
   g. resolution of displaying media,
   h. listing of all the presenters and moderators for this session,
   i. any filters to apply to the media for viewing or downloading purposes (e.g. apply black and white filter to media (slides) downloaded) and types of downloadable formats allowed (PDF, DOCX, PPTX, raw media files etc.),
   j. whether any watermark, copyright message is to applied to the media, color/logo to use for downloads and reporting purposes, features enabled-disabled for attendees profile matching a criteria—for instance those logged in using LinkedIn are able to download the content while others are not allowed to
   k. whether the content can be shared on social media—for instance attendees can be permitted to tweet the image of the slide or to email the slide and/or link
   l. whether the questions asked by attendees in the session get moderated before other attendees get to see it
   m. perform automatic checks for profanity in contributions by the attendees
   n. the presenter may choose to configure and use a companion internet connected computing device e.g. smartphone or tablet running DialogLoop software to control his presentation from afar giving the presenter more freedom to engage with his audience. This companion device acts like a remote control for all features available on the DLPS.
9) Based on the above configuration the host adapter generates a request to create a session to the DLPS. This request to a DLPS session API is accompanied by data in JavaScript Object Notation (JSON) format and may include the authentication token.
   Note: JSON (JavaScript Object Notation) is a lightweight data-interchange format. It is easy for humans to read and write. It is easy for machines to parse and generate.

```
{
    “Title”: “DialogLoop Presentation”,
    “Author”: “DialogLoop”,
    “Description”: “This Presentation was enhanced using DialogLoop”,
    “Date”: “June 25th 2017 @ 0:01 PM”,
    “Length”: 50,
    “PresenterId”: “MRRDCNJUGJQWILJUGJSGILJUGJ”,
    “Handle”: “MRRDCNJUGJQWILJUGJSGILJUGJ”,
    “Props”: {
    }
}
```

10) The DLPS creates the required entries into the databases and folders on the servers and ties the data together with a unique sessionId.
11) Once the Host Application Adapter receives information that DLPS has successfully created a session with session id, all further communication occur with this id.

```
{
        ...
        “id”: “db9bc3f0-2e30-45a4-6d3a-2e8cbc02eda0”,
        ...
}
```

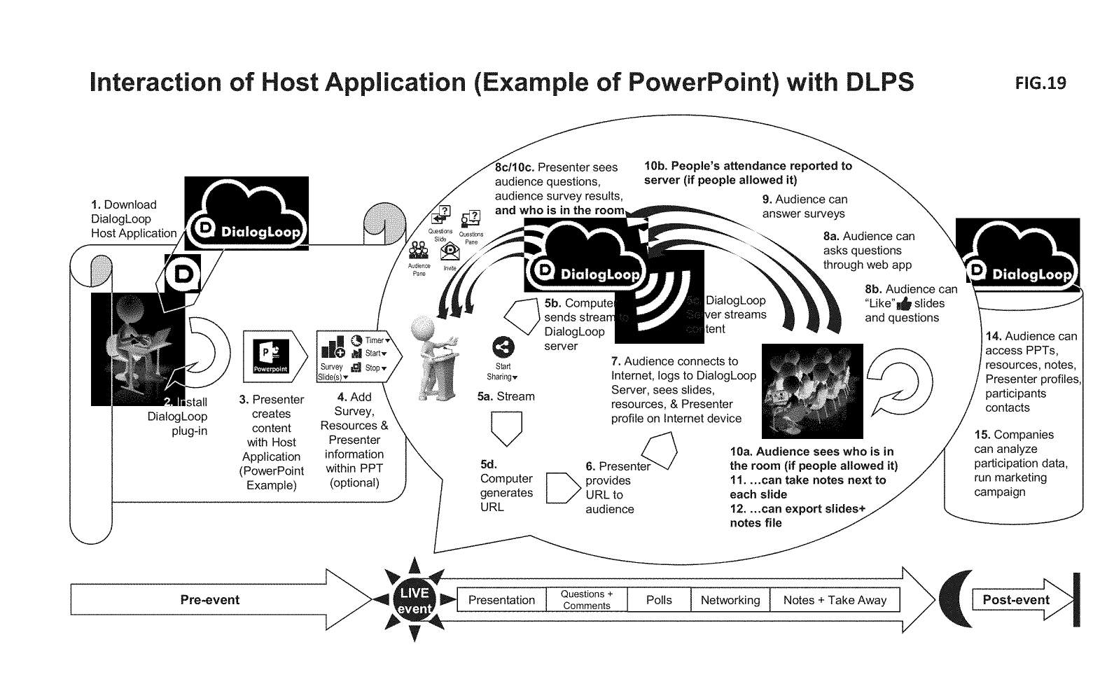

12) The Host Application Adapter (e.g. PowerPoint Add-In) is ready to push content (slides and resources) into the session and prepares to start receiving messages from the DLPS. It has multiple ways in which to upload presentation content to the DLPS. In one example all the configured slides are processed at one time, media and meta-data is generated and an upload package is created. This package is then uploaded to the DLPS via the content upload API. If the presenter adds a new slide it is uploaded along with the associated resources in real-time or if a slide is deleted it is deleted on the DLPS ensuring that the attendees are always synchronized with the presenter in real-time.
13) Upon successful uploading of content, the host adapter finalizes the session by generating a URL Slide that displays the web address the attendees can visit to access this shared presentation. If the web address was pre-configured before the sharing began it is used. Otherwise a new system generated web address is used.
14) This PowerPoint presentation is now DialogLoop ready.
15) As the presenter progresses through the presentation i.e. changes slides, it is progressively revealed to the attendees in this DialogLoop session. Progressive-reveal allows the presenters to make their content visible to the attendees on the DialogLoop platform just in time, when the presenter wants to display it and not before. For example a particular slide is revealed to the attendees on their device only when the presenter switches to that slide inside the presentation host application (e.g. PowerPoint) and not before. If the Presentation is also displayed on a large screen/projector—the attendees viewing the content on their devices on the DialogLoop Platform get the slide when it's visible to the audience at large. The attendees on the DialogLoop Platform are able to use the various content related functionality offered by the DLPS including but not limited to:
   1) The ability to go back and review all the slides previously revealed. The attendee can sync up with the presenter to view the presenter's current slide. This also enables attendees who join late to review content that was already covered.
   2) Annotate/take notes on any of the revealed slides including using digital ink
   3) Like the slides
   4) Ask questions related to the slides
   5) Download/share their notes/annotation
   6) If allowed by the presenter, share the revealed slides with others using the methods provided and/or download them as digital handouts (slides along with the user's annotation and notes) in a format permitted by the presenter.
   See 1100 DialogLoop Platform Services for details. When content changes inside the host application (e.g. slide change inside PowerPoint) the Host Application Adapter (e.g. PowerPoint Add-In) determines if the DialogLoop Platform Services already has knowledge and latest information on the slide that was just made active/selected.
      If yes (DLPS is already aware of the latest information) then the PowerPoint Add-In makes a DialogLoop Platform Service API call to make this slide the active/selected slide along with meta-data.
      If not, then the PowerPoint Add-In—generates the media that will represent the new slide and computes the meta-data describing the new media in real-time including but not limited to the slide ID, the position of the new slide and more. The PowerPoint Add-In uploads the new media along with the meta-data to the DialogLoop Platform Services, marking it as the active/selected slide.
16) The presenter is able to enhance the experience of the presentation by incorporating advanced features offered by DLPS. One such feature is the Surveys/Polls/Quizzes. The presenter can incorporate live polls, surveys and quizzes into their presentation. The reader is advised that in this document the word Surveys, Polls or Quizzes will be used interchangeably. See 1160 DialogLoop Survey System for details.
17) The presenter is also able to insert one or more Live Questions Slide into the Host Application (e.g. PowerPoint) each configured with preferred criteria. As attendees submit questions from their connected devices and other attendees “vote on” questions, each Live Questions Slide ranks/filters all the questions based on preferred/pre-defined criteria and displays the results live on the slide. The slide can update LIVE from the moment the presenter starts streaming. See 1170 DialogLoop Live Questions Slide
18) As presenters progress with their presentation and engage with the attendees using live polls and live questions, new information is generated in real-time from the attendee responses. This new information could be re-injected into the Host Application in real-time, creating new media (e.g. one or more new slides inside PowerPoint). The presenter may choose to share this newly generated information and/or media (e.g. Slides) with the attendees, ensuring they have the latest copy of the presentation along with the content that was co-created by the presenter and the attendees in real-time. See 1150 Re-injection of real-time information back into the Host Application
19) When the presentation is finished, the presenter may:
   a. Choose to keep all or some of his content available to the attendee
   b. Choose to delete his content
   c. Choose to reconnect at a later time to re-engage with the attendee e.g. answering questions, updating poll responses, if they were still running, and generating interactivity reports. If enabled, new users who were previously unable to attend the presentation are able to view and interact with the presentation.
   d. See 1190 Reconnect to a DialogLoop Session
20) FIG. 19 shows the interaction between the Host Application Adapter and DLPS.

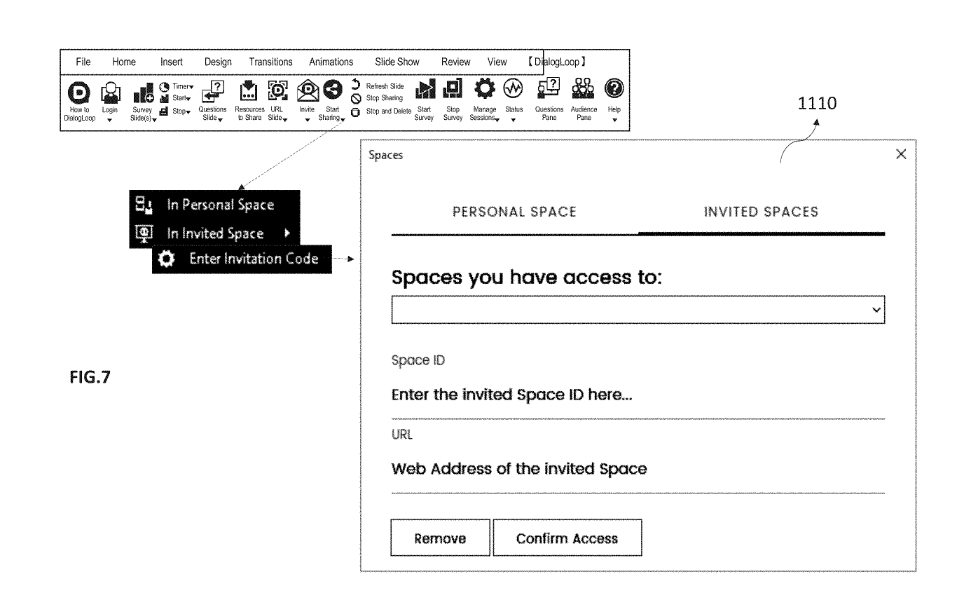

### 1110 DialogLoop Space (FIG. 7)

FIG. 7 shows how presenters work with DialogLoop Spaces.

A DialogLoop space is a virtual folder in the cloud that brings all DialogLoop sessions together in one view from an attendee perspective. A space can belong to a presenter, an event, an organization, a topic and more. Some examples of spaces include: “tedtalks”, “tonyrobbins”, “conference2017”, “unitednations”, and “malaria”.

A DialogLoop Space allows an event attendee to use one address to find all the DialogLoop Sessions related to the event/topic even though there may be multiple presentations by multiple presenters.

Spaces allow multiple presenters to push content to a shared space. In one example Presenter 501 and Presenter 502, working on different computing devices, could share/stream their content to an invited DialogLoop Space called “conference2017”. The attendees are now able to see content from both the presenters in the conference2017 space.

When a presenter registers with the DLPS, they get their own space which may be a computer generated unique ID. The presenter is then able to update their space to something more meaningful and humanreadable. For example, Space name could be the name of the business or an event they will be hosting.

The presenter has the choice to configure their Host Application Adapter to share/stream content to their personal space or to an invited space owned by other presenters, event organizers and/or businesses. For example, a presenter is able to share/stream her content in real time to an event organizers space if authorized by the event organizer.

DLPS keeps track of all DialogLoop Sessions pushed to a particular space.

A DialogLoop Space/DialogLoop Session may further be configured to require authentication or a passcode before users are allowed access.

1300 Multi-Media Recording and Sync-Up with Content (FIG. 12)

FIG. 12 describes how the Host Application Adapter and DLPS work together to enable creation of multimedia recording of the live presentation without the added preparation and costs. These recordings can be accessed by attendees in real-time or made available at a later time, depending on the situation. To build this multi-media recording with synchronized content, the system can leverage:
Audio/Video feed available from the Audio/Video equipment in the room, or
Commodity hardware available on the computing device running the DialogLoop host adaptor or
Companion internet connected device authenticated with the DialogLoop Platform Services or
Combination of the above
   1) Step 1301 includes:
      a. Initializing the audio/video channels based on the configuration specified by the DLPS for the Presenter
      b. Opening the recording device using platform APIs
      c. Allocate memory for cyclical memory buffers for capturing multi-media input from the channel.
      d. Manage memory and buffers to record audio that can be processed and associated with the DialogLoop session.
   2) Step 1302 includes:
      Generation of a bookmark when triggered. Bookmarks allow the attendees who join the session to have control on their Session viewing experience. Attendees can move back and forward in the DialogLoop session by clicking on the available bookmarks. The attendees may be able to experience the audio, video and other user generated content that was enabled and captured by the DLPS for the session.
      The bookmark creation can get triggered manually for example, when the slide changes or automatically by the DialogLoop session when certain activities or thresholds are reached in the DialogLoop session.
      a. Step 1304—A snapshot can be triggered by multiple events not limited to but including:
         i. Slide changes or content changed on the slide e.g. animations completed or updates were pushed from the Presenter's device, to the attendee's device like in the case of survey results.
         ii. The DialogLoop session crossed a configured threshold e.g. when the number of people joined and/or left the DialogLoop session; a certain number of people from a social network joined e.g. LinkedIn or the number of questions or votes reached a threshold.
      A bookmark may include the following information and more depending on the situation:
      b. The current Slide number/Id
      c. Time since the last slide change, and/or beginning of DialogLoop Session
      d. Meta-data and State stored in the DialogLoop session e.g. the number of people in the session, number of Likes or shares on social media, when attendees clicked a particular actionable link, when attendees completed a poll/survey
      e. Index the associated multi-media that allows the attendee to go to that point in time.

Step 1305: Digital recording of multi-media, such as audio and video, using one or more devices coupled to the DialogLoop Platform Services using the internet.

Step 1303: Update DialogLoop Session on DialogLoop Platform Services
1. Synchronize multi-media and bookmark information and any other information with the DialogLoop Server for this DialogLoop Session
2. DLPS can enable real-time speech-to-text of the recorded audio, closed captioning, translation and transcription services by incorporating capabilities of machine learning and artificial intelligence services.
3. All the bookmarks can be exported and visualized on a timeline, showing the slides, the Audio Wave form of the recording, all the questions, the likes, the tweets and all the attendees who came and left.

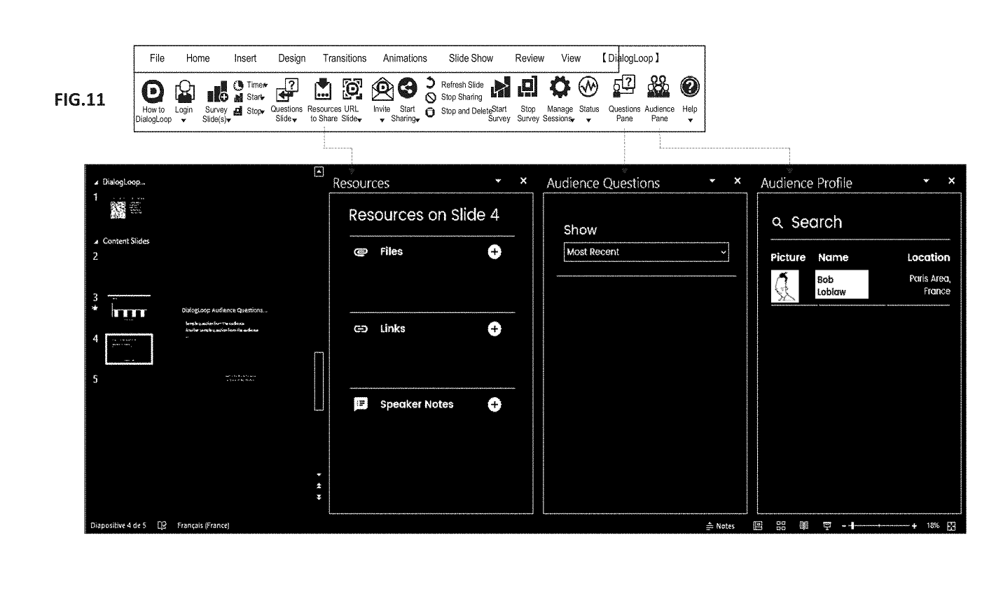

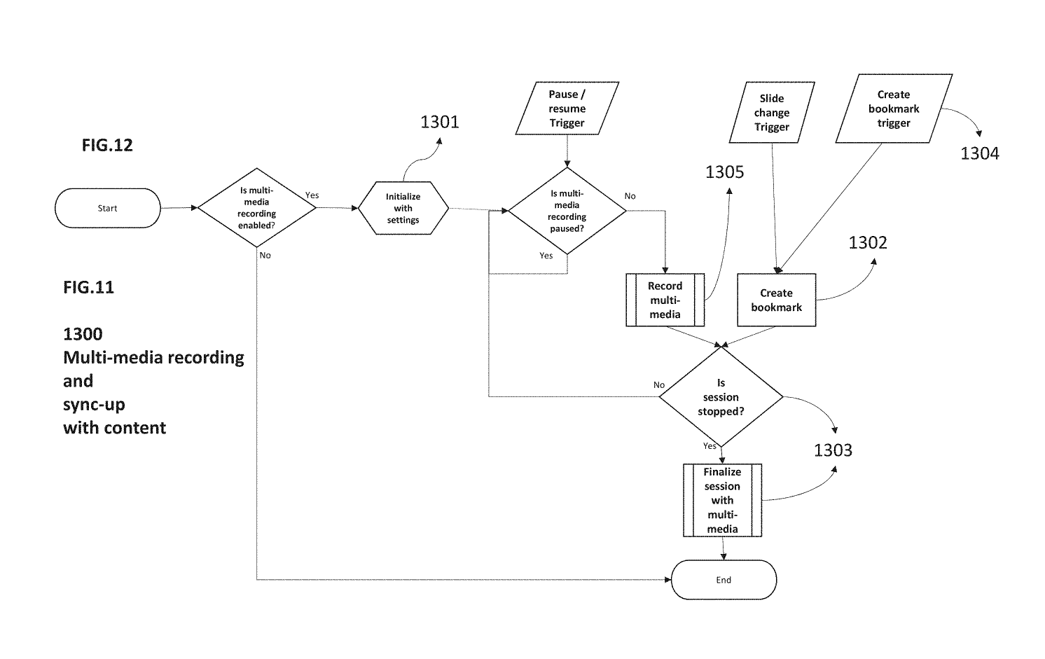

### 1130 Resources on the DialogLoop Platform. (FIG. 11)

FIG. 11 shows how the presenter shares resources in the presentation
Resources allows presenters to seamlessly share resources/supplementary material (such as files, links, notes and more).
1) The Presenter selects resources to share for each individual slide. For example: the presenter selects a file using the file browser on his computing device or enters the link the attendee should visit.
2) When the presenter starts sharing, all the resources are uploaded and managed automatically.
3) These Resources are progressively revealed to the attendees when they are viewing the slide that introduces the resource.
4) The Attendees get immediate seamless access to these resources via actionable links as part of the DialogLoop Session and don't need to remember to go elsewhere for access.
5) A summary of all the resources and how to access it is generated to enable the attendee to have all shared content in one place. The resource summary is also inserted into the document generated as part of the downloading of content by the attendee.
6) The resource information is stored along with other DialogLoop Session information.
7) The Host Application Adapter ensures all resources are reference counted to ensure that only one copy of a file is uploaded to the DLPS even though they may be shared on multiple slides.
8) The Host Application Adapter enumerates links and media already embedded in the Slide e.g. URLs, email and social media links automatically generate actionable links on the DialogLoop Platform. When a shape on the slide with a link is encountered, a DialogLoop resource is automatically created and shared on the DialogLoop platform. When a multi-media (video) element is encountered on a slide, the media can be extracted and uploaded like a resource file with a link automatically generated and shared on the DialogLoop Platform.
9) All resource links are actionable and trackable by the DLPS and can be included as part of the real-time DialogLoop Session activity reporting.

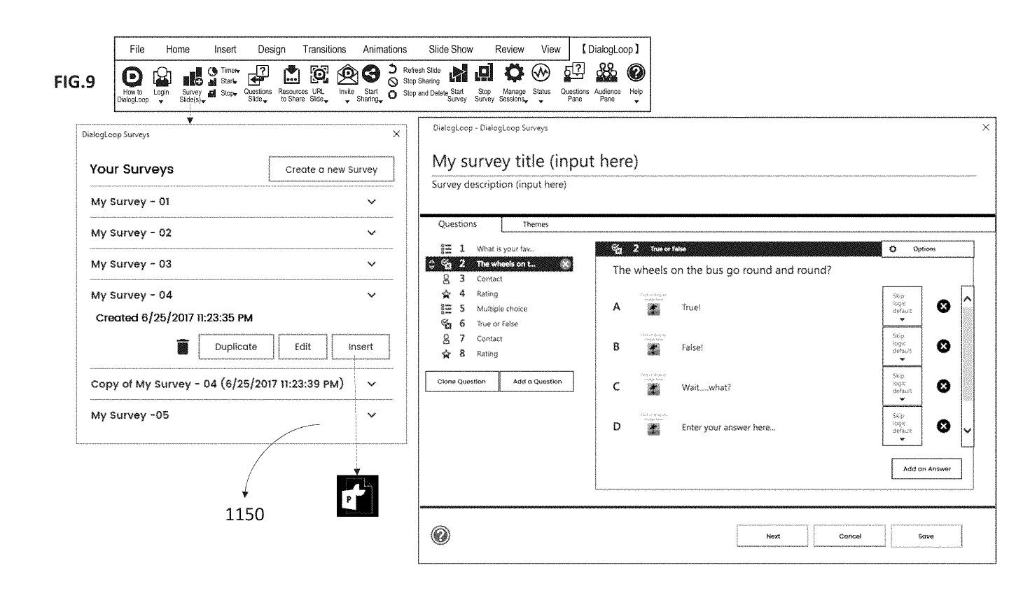

1160—DialogLoop Survey System (FIG. 9)
FIG. 9 shows the DialogLoop Survey system. It consists of the following components:
   Survey Builder—helps build the survey
   Survey Conductor—helps take the survey
   Response Processor—processes responses
   Results Visualizer—populates the responses once processed
   The following example describes how the DialogLoop Survey System is integrated into the Host Application (PowerPoint) via the Host AddIn Adapter (DialogLoop Add-In for PowerPoint). Reader is advised that similar integration is possible with other Host Applications. See 1500 DialogLoop Host Application Adapter
   The Survey Builder is WYSIWYG (what you see is what you get) editor that allows a presenter to create a new poll/survey by defining a name, the questions, the answers, and the appearance. Supported question types include: Multiple-choice. Rate, Yes/No, Sort, Contact, Open answer. Images can also be used as clickable answers. The look and feel can be customized by creating themes where one can incorporate logos and colors. Internally a survey/poll/quiz is represented by a JSON as shown below.

{
“id”: “c06c7529-0362-46b5-ab18-0adc68a9a045”,
“version”: “1.1.0”,
“title”: “Test Survey”,
“questions”: [
{
“type”: “multiChoiceQuestion”,
“answers”: [
{
“text”: “Innovative”,
“id”: “36e2aed0-3ae7-455e-8cf1-025d7f94dd6b”
},
{
“text”: “Extremely Innovative”,
“id”: “9303b706-a757-4041-b86e-5172dd72e63f”
},
{
“text”: “Insanely Innovative”,
“id”: “43ad7682-e955-4d5d-b93e-f251155b5663”
}
],
“id”: “53a77561-6201-4cfc-aa4e-5de5b8d6828b”,
“text”: “Please choose whether DialogLoop is”
},
{
“type”: “openQuestion”,
“id”: “e6b4b113-801c-4caf-a169-f412ed7732c3”,
“text”: “Please write a short review”,
“maxLength”: “75”
},
{
“type”: “contactQuestion”,
“id”: “9cfcbd0f-3196-443d-88ec-9ecc571ca874”,
“text”: “Please provide your contact info:”,
“fields”: [
{
“label”: “First Name”,
“id”: “e6a49d2e-09b7-4bb1-ab84-9168f67bba1a”
},
{
“label”: “Email”,
“id”: “59507299-c479-4d3b-b244-156db6cc5adf”
},
{
“label”: “Phone”,
“id”: “4f7c8622-3ded-434f-8012-9cce5b39670c”
}
]
}
]
}

Once a survey is defined, it becomes like a template and can be used and re-used (also called inserted or instantiated) multiple times in the same presentation or in different presentations. Each inserted survey is unique and gets its own and unique “instanceId” even though it has the same questions and/or theme(s). In one example, this enables the presenter to use a survey at the start of a presentation and re-use it again towards the end of the presentation. This enables the presenter to compare and contrast how the presented content influenced the attendees.

```
{
  “instanceId”: “887c8622-3ded-434f-8012-9cce5b39670c”
        “id”: “c06c7529-0362-46b5-ab18-0adc68a9a045”,
        “version”: “1.1.0”,
        “title”: “Test Survey”,
        “questions”: [...
}
```

The Presenter is able to insert multiple surveys on a slide, and can start them simultaneously. The attendees may choose to respond and submit surveys in any order they choose. Each survey is represented by a unique survey instance ID and each response has the survey instance Id it is associated with. The system is able to handle survey interactions and events in any order.

Each instance of a survey:
a. Is self-contained and its internal representation (JSON) can be sent out over the DLPS messaging service to attendees (all or select few depending on the situation).
b. It may have a visualizer associated with it which is a visual representation inside the PowerPoint with the capability to render attendee responses to the survey questions. In one example: A visualizer for a multiple-choice question could be a bar graph. These graphs can be powered by a spreadsheet application like Microsoft Excel or modern business intelligence and data science software applications like plot.ly or D3.js. In another example: the contact question could render all submitted responses into a Table with each field being a column in this table.
c. Can be configured on how and when it gets started. In one example: the presenter can choose to launch the survey manually by clicking on the “Start Survey” button. In another example the presenter launches the survey by using the Survey Launcher tool on the slide.
d. When it receives a “Start Survey” message, an attendee's client application may in one example choose to display a notification to the attendee.
   The attendee is then able to click on the notification to launch the Survey conductor. They are able to submit their response when done.
e. Responses to surveys can be received by the DLPS in real-time in the order submitted and sent over the DLPS messaging service in the case of a LIVE session and/or are also available via a DLPS API call when it is time to refresh survey responses. For example when the presenter reconnects to an existing DialogLoop Session that had a survey already in progress.
f. When processing responses, the Host Application Adapter (PowerPoint Add-In) intelligently manages responses to avoid duplicate submissions from attendees and update the visualizers.
g. At any time or when the survey is stopped, the presenters may choose to push the updated PowerPoint slide with visualized responses from attendees to some or all of the attendees. This enables the attendees to have the latest version of the slides at all times that is synchronized with the presenter.

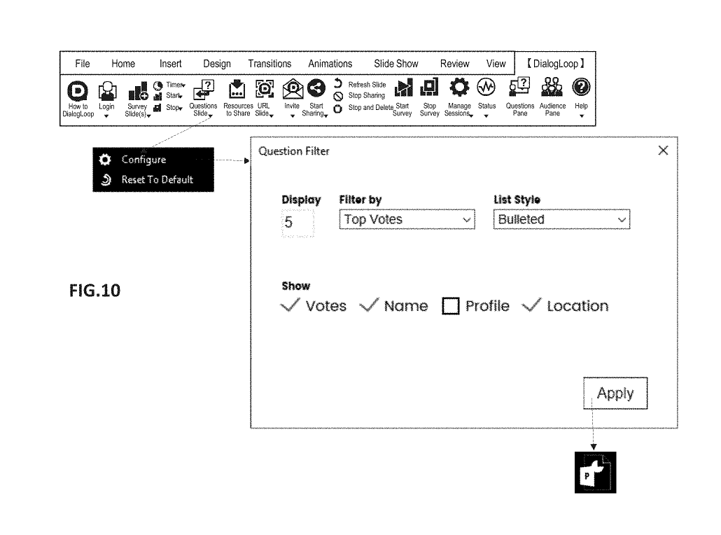

### 1170 DialogLoop Live Questions Slide (FIG. 10)

### FIG. 10 Shows how a Presenter can Configure a Live Questions Slide.

The Host Application Adapter manages the Live Questions Slide.

The DLPS messaging architecture sends/pumps question information in a Session LIVE to all connected users including the Host Application. The Host Application Adapter listens to these changes giving each live Questions Slide an opportunity to update its content based on the results of the filter. There are optimizations put in place to ensure the slide is only updated if the live filter yields new information.

### 1102 Presenter Profile Cards (FIG. 6)

FIG. 6 Shows how a presenter creates a presenter profile card.

The Host Application Provider (PowerPoint Add-In) allows the creation of one or more profile cards for the presenters and/or organizations, with actionable links that allow attendees to learn more about the event, the organizer, the presenter, and the topic.

The Profile Builder is a WYSIWYG editor to create profile cards by defining one more links with icons and labels and other information. Internally a profile card is represented by a JSON as shown below.

```
{
    “id”: “8ffe84a8-4727-4452-b0d1-83f38a255af9”,
    “title”: “Firstname Lastname”,
    “description”: “CEO of Company”,
    “message”: “Company mission”,
    “picture”: “https://URL/companylogo.jpg”,
    “href”: “https://companyurl.com”,
    “items”: [{
        “id”: “c253d72e-15aa-4b10-8285-6222bdc8e2cc”,
        “label”: “Company on LinkedIn”,
        “href”: “https://www.linkedin.com/in/company/”,
    }]
}
```

The presenter has the ability to embed a presenter profile into a presentation.

At DialogLoop session creation time, priority is given to embedded profiles found within the presentation.

When DialogLoop Session uses a presenter profile, all required information is stored in the DialogLoop Session's Props field (See 1100 DialogLoop Platform Services).

Each profile card appears like a digital business card with actionable links on attendee devices.

It is displayed to attendees based on the criteria defined by the presenter or the event organizers.

All links are actionable and trackable by the DLPS and can be included as part of the real-time DialogLoop Session activity reporting.

### 1400 Live Simultaneous Multi-Language Slide, Automatic Slide Translations and Closed Captioning.

This allows attendees to control how they view slides and content. The attendee may have a preferred language or layout that could be different than that of the presenters.

For example, the presenter may choose to present an English copy to the audience in the room while an attendee may choose to view the corresponding French copy, if and when available, while another attendee may choose to view an Arabic version of the presentation, if and when available, on their connected device. All features described in this document would apply to simultaneous multi-language casting including resources, surveys and more.

DLPS provides multiple ways to accomplish this depending on the amount of work required.

A) If the presenter is able to create different copies of the content (e.g. for the languages they wish to support, for instance English, French, Spanish), then DLPS maintains a mapping of which media (e.g. slides) and resources go together. Once the different copies of the content is created the presenter is able to specify different copies of his presentation/slides to serve different attendees based on their preferences.
B) Alternatively, DLPS is able to leverage its micro-service architecture and messaging infrastructure along with capabilities of machine learning/artificial intelligence to provide real-time translation of the content including slides and the information on the slides.

More control over the quality of output and translations can be achieved by preserving the text and layout information of each object on a slide. The translated text replaces original text at the same location. A new slide can be generated in real-time that can be overlaid on top of the original slide.

### 1190 Reconnect to a DialogLoop Session

The presenter may choose to keep the DialogLoop Session after his live presentation to extend the reach of his content. The DialogLoop session information is stored inside the Host Application document (e.g. PowerPoint presentation) giving the presenter the option to reconnect to the session when he/she opens the respective presentation file. This helps the presenter stay connected with his audience post live session, monitor and answer questions, update survey responses, generate leads and continue the conversation with his community.

Reconnecting to a session:
When the presenter opens a PowerPoint presentation the software checks if there was an existing DialogLoop session associated with this file. Upon validation that the logged-in user has access to connect to the DialogLoop session online, the user is prompted to re-connect to the existing DialogLoop session.
Once the user chooses to reconnect, the integration (e.g. PowerPoint Add-In) allows the presenter to gain control of the session based on their privilege and access levels. In this example, the presenter has full access (from a device) and the presentation in control of the dialog loop session.

When in control—

The web clients are notified of slide changes, slide content is refreshed (slides are added, updated, or deleted) based on their slideId, and session properties are updated to reflect the current state of the presentation.

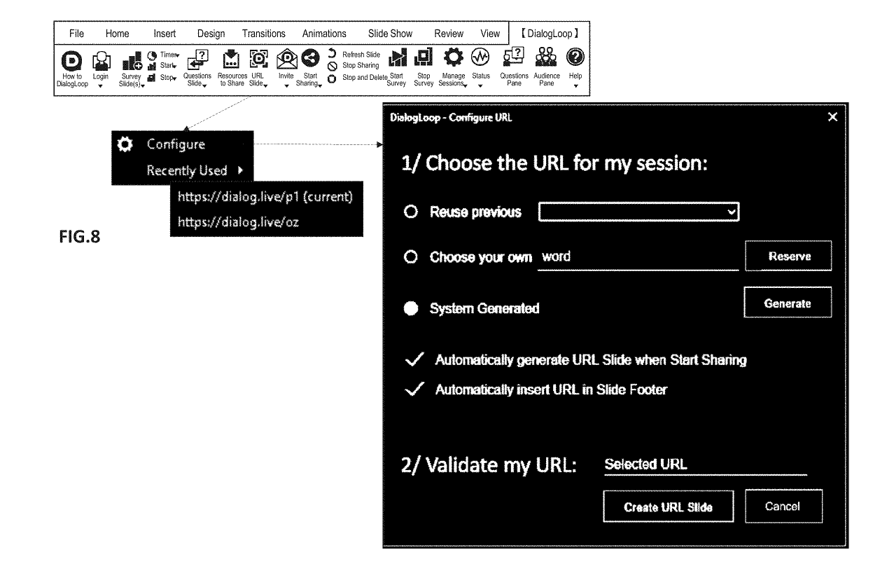

### 1120 Session URL and URL Slide (FIG. 8)

FIG. 8 shows how presenters configure a URL for a presentation
By default DLPS assigns every shared/streamed presentation a short URL to make it easy and less error prone for attendees to type the URL.
The presenter can choose to reuse an existing URL, request the DLPS to generate a random one, or reserve a custom word (if available) for the short URL. In one example a presentation may be accesBible on the internet via https://dialog.live/demo.
To aid the presenter, the Host Application Adapter provides an easy way to insert the URL information onto a slide in the presentation along with a QR code and instructions.
   1150 Re-Injection of Real-Time Information Back into the Host Application

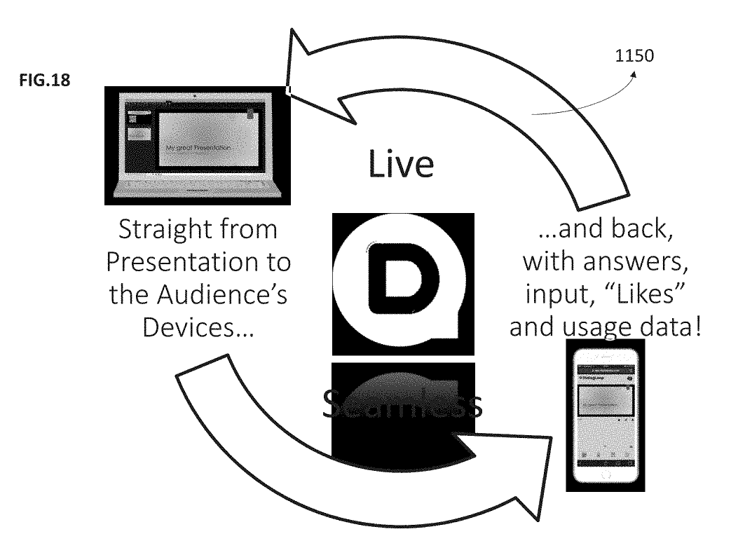

### FIG. 18 Shows Re-Injection of Real-Time Information

DialogLoop has the ability to do a live and automatic update of existing slides or addition of one or more new slides into the host application (e.g. Microsoft Presentation) with real-time information that can be shared with the attendees immediately. For example:
Survey responses are shown live in Live PowerPoint Survey Slide
Live Questions Slides provide a real-time view of attendee questions.
Audience Statistics (demographics)—processed in real-time by the DLPS, with up-to-date information and rich information visualizations/maps/graphs ready to be presented in real-time.
Audience interactivity reporting in real-time in a live slide (e.g. likes, tweets, questions, polls, user engagement levels and more) ready to be presented live in real-time.

### 1500 DialogLoop Host Application Adapter

The Host Application Adapter translates objects/commands from the native application into data and format that is compatible with the DialogLoop Platform Services. For example the DialogLoop Add-In for Microsoft PowerPoint using the Microsoft PowerPoint Object Model and APIs to export the PowerPoint slides into a media format e.g. Images (JPEG, PNG, GIF)—a format that can easily be rendered on clients devices 701-703. It has the ability to send and also receive content/information/notification messages in real-time to one, selected few or all client device via the DialogLoop Platform Services 1100.

There are numerous ways to create host application adapters leveraging local processing capacity or by offloading some work to services remotely.

The DialogLoop Host Application Adapter may maintain state depending on the situation helping it with context caching information from previous requests to the DialogLoop Platform Services.

It may keep the information encrypted or unencrypted as the situation requires.

The different levels and types of DialogLoop Host Application Adapter's include:
1) A plugin like the DialogLoop Add-In for PowerPoint that is tightly integrated with the host application and works along with it to create a dialog loop on top of the native document format.
2) An independent application that works on an operating system such as Apple iOS to integrate DialogLoop functionality with the operating system features. E.g. create a dialog loop using content from the camera roll or photo's application.
3) A service that automatically creates dialog loops on top of content attached to an email address from a registered email address.
4) A service that executes along slide the host application when full integration is not possible.
5) A cloud service that allows a presenter to upload files of types *.pptx, *.docx, *.pdf and many others to be ingested on the server to automatically create dialog loops for these uploaded files.
6) A piece of software on an internet connected hardware/device that accepts files from authorized sources using physical or wireless connection to create dialog loops for the transferred files.
7) A service running on hardware such as a USB key that automatically creates dialog loops for the transferred files.
8) A service monitoring virtual folders to create dialog loops for included files. These virtual folders could be on storage providers including Dropbox, box.net, Microsoft one drive, google drive or on content management systems and portas1 like SharePoint, blackboard, and desire2learn.
9) A library, components and/or set of controls that integrates into an existing 3^{rd} party application to enable DialogLoop Platform Services integration into the 3^{rd} party application.
10) A web component that integrates with other Web content on a Web site or Web Application to enable DialogLoop Platform Services integration into the Web media content. For example, enable dialog loops on top of live streaming of content on a Web site.

### 1100 DialogLoop Platform Services

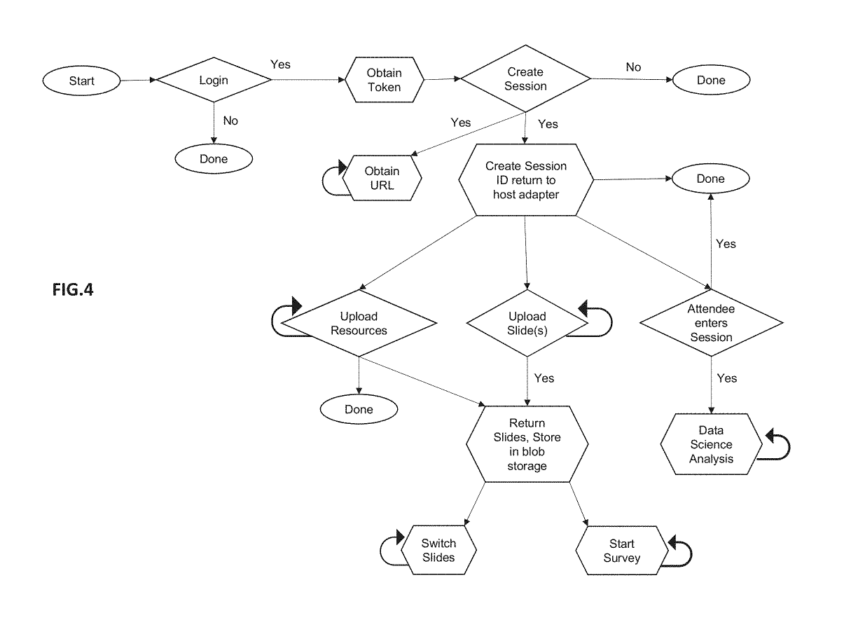

FIG. 4 is a Flow Chart for creating and managing a DialogLoop Session

The steps of the flowchart are not restricted to the exact order shown, and, in other configurations, shown steps may be omitted or other intermediate steps added.

The DialogLoop Platform Service leverages:
Micro service architecture allows the team to iterate on different parts of the architecture and scale independently as the new features are added and/or requirements change. For example: User management, authentication and login are provided as their own service. In another example, a Worker queuing system feeds data to the networking data science bot service and to proprietary and 3^{rd} party machine learning services that processes and sends back results as and when required.
Data architecture that uses a mix of structured and unstructured data formats giving the team the freedom to quickly iterate, modify and expand functionality without relying on major redesign of the architecture or schema changes. JavaScript Object Notation is the preferred format for serializing and transmitting data over a network connection. Every concept on the platform is extensible and exposes a Props field represented by an object/map/dictionary that can be expanded as and when required. Secure databases, file/blob storage, caching of information and content delivery networks (CDNs) are relied upon depending on the situation.
Messaging architecture allows for real-time updates; enabling functionality like chatting amongst Platform users and generation and communication of personalized recommendations from the networking service. It also enables communicating state changes and status information to clients and host application adapters including when attendees join or leave the session. It has the ability to send large amounts of data including images, video frames and more. Built on web standards, this system can easily and freely send new types of messages between clients and/or host adapters who may decide to handle or ignore them.

High Level Capabilities of the DialogLoop Platform Services (DLPS) through a series of REST
API's or services. Note this is not an exhaustive list.
1.) Manage login and authentication
Allow login via third party providers including but not limited to LinkedIn, Facebook, Twitter,
and others
Request consent for attendee data usage in compliance with GDPR (2018)
DialogLoop Account where - DLPS is the login provider.
Anonymous login where user has limited access to DLPS and no credentials are stored
All methods uniformly return an access token that allows DialogLoop Clients or Host Application
Adapter (e.g. Microsoft PowerPoint Add-In) to access the offered services
Dedicated communication channel for each session, for real-time information updates, data-
transfer of media along with various messages pertaining to surveys, questions and chatting
amongst users on the platform and more.
2.) Manage/Create/Modify/Delete Sessions
List available sessions (filtered by date, presenter, tag, space etc . . .)
Access session information
Upload one, several or all media for a session (e.g. upload some or all all slide information
from a Microsoft PowerPoint Presentation)
3.) Modify/Update/Delete Slides
Obtain first or current media (e.g. Slide) of the session
Obtain any media (e.g. Slide) anywhere in the session
Change the current media (e.g. Slide)
Like a media (e.g. Slide)
4.) Track/List Attendees
Get attendees in a session
Know the status of whether or not a person is currently in a session
Obtain meta-data about attendees in the session
5.) Start/Stop/Track Surveys
Start or Stop surveys via the session dedicated communication channel
Relay responses to presenter and track responses for historical purposes
Track given surveys for historical purposes
6.) Peer to peer, one to many and many to many communication
Ability for clients and host application adapters to send messages, default and custom or
various media to and client, devices or system connected to the dedicated communication channel
for a session
7.) Track/Update/Create Resources
Can store any type of media and recall or replace that media for a session
Ability to track resources via reference to avoid explicit copying
8.) Track/Update/Create/Delete Users
Unique identifier for a user, which can be a presenter, event organization, group, organization,
moderator, bot or other kind of entity
Create these users and store the equivalent meta-data, storing information to determine identity
along with work history, connections and various other meta-data as allowed by the user
of the system
Link social accounts to DialogLoop's unique identifier so all social account identities and
media are contained under one unified place
Restricted access to the list of all users and meta-data
9.) Track/Create/Update/Delete Questions
Allow questions to be shared with everyone in the session and/or require moderation before
being shared, apply checks before making questions visible to one, all, select few in the session
Like a question
Remove questions
Modify question(s) wording
mark questions as answered
10.) Post to social media with user permission
11.) URL shortening service
12.) Queue managed data-science service
Queue and respond to requests for session analysis in real-time or near real-time, which includes
specifying type of analysis, applicable filters and interested attendees

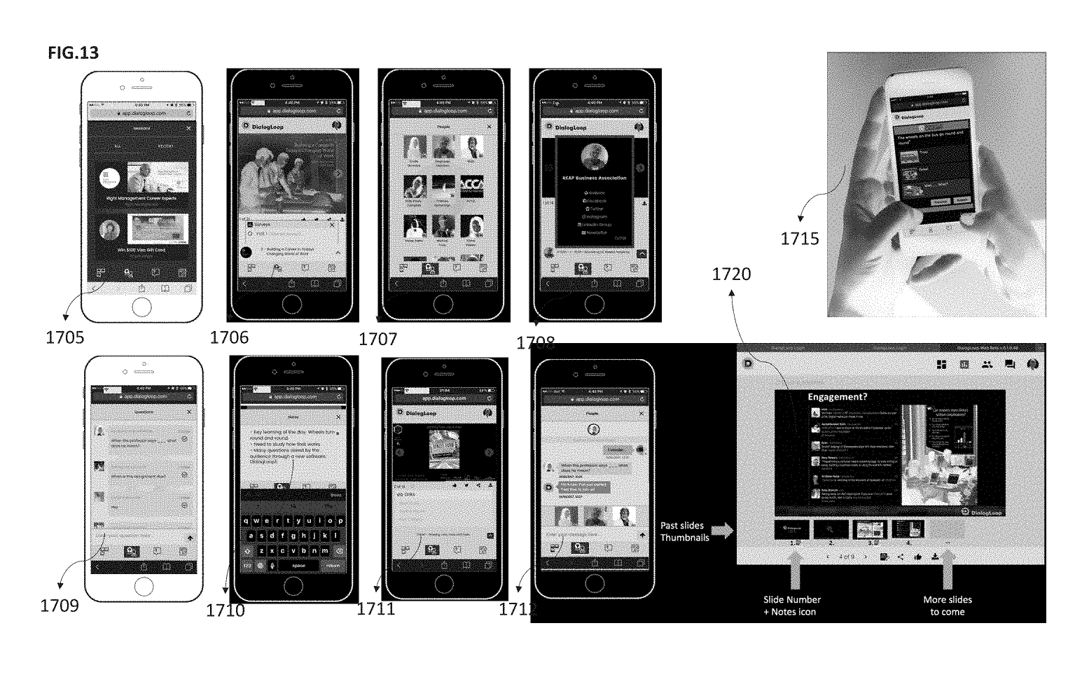

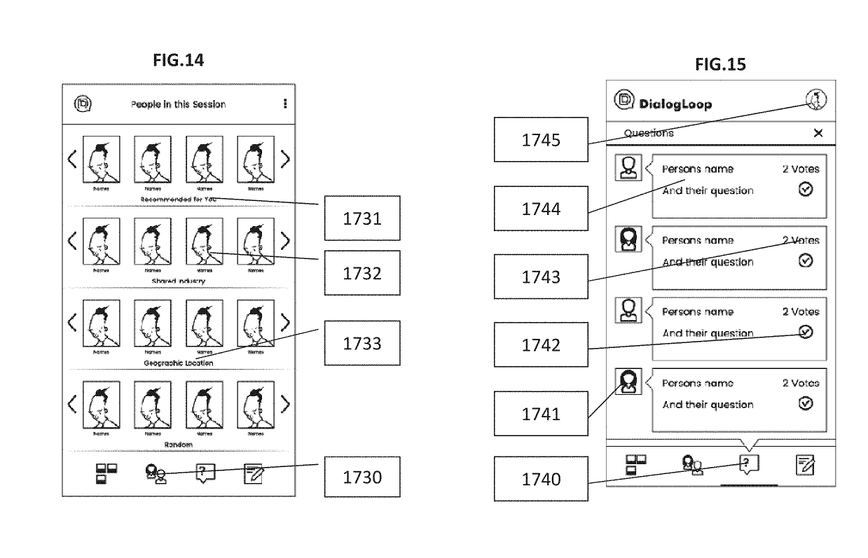

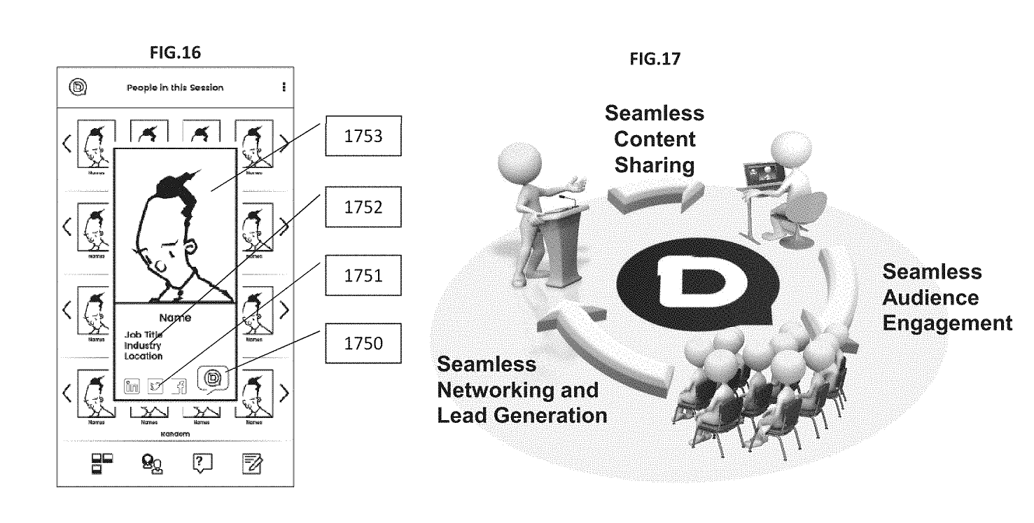

### 1700 DialogLoop Clients (FIG. 13, FIG. 14, FIG. 15 and FIG. 16)

This is client software developed by DialogLoop or 3^{rd} party to integrate with DialogLoop Platform Services 1100. Examples include the DialogLoop Web App.
FIG. 13 shows examples of different displays of a client application.
   1705 is one example of a DialogLoop Space. An attendee logged-in and authenticated by the DLPS will be able to see all the DialogLoop Sessions running in a DialogLoop Space.
   1706 is one example of media shown to attendees when they enter a session in 1705. 1720 is another example of 1706 where the media adjusts to a wider format displaying more information and depends on the capabilities of the attendee's client device.
   1707 is one example of a screen displaying all the attendees in the session along with the client attendee (one who is logged in).
   1708 is one example of the Presenter Profile Card that is displayed to the attendee (when they enter a session or when they click on the Presenter Image).
   1709 is one example of a screen where attendees can type or record using the built-in device microphone. They may also be able to vote on other attendee questions.
   1710 is one example of a screen where the attendee can take notes. These notes may be associated with the slide. The attendee can share/download their notes and the slides if permitted.
   1711 is one example of a screen where attendees can view the resources shared by the presenter. These resources could be links, files and/or notes.
   1712 is one example of the chat UI display within DialogLoop. Attendees may be able to chat with each other, depending on the situation and configuration.
   1715 is one example of a poll UI display viewed by attendees when a poll sent out by the presenter.
FIG. 14 shows the different options for the People view.
   1730 is the launcher for the People view. It displays all the people currently in this DialogLoop Session.
   1731 is one example of how recommendations from the DLPS networking service could be displayed to an attendee. The entries and information displayed in this section could be different for each attendee depending the situation and configuration, which could be set up by the individual attendee themselves, administrator, DLPS, presenter or the event organizer.
   1732 is one example of how attendee profile cards are displayed. The logged-in user is able to click on each profile card and get more info.
   1733 is one example of how the attendee information can be displayed based on different criteria e.g. industry, geographic location etc.
FIG. 15 shows the Questions view
   1740 is the launcher for the Questions view. It displays the questions currently in this DialogLoop Session and the content is controlled by the moderator, presenter and/or administrator. This view also has an area (not shown) where the attendee can type, review and submit their question(s).
   1741 displays the name and image of the attendee asking the question or a generic image depending on the situation e.g. if the attendee desires to be semi-anonymous to others in the session.
   1742 allows the attendee to vote on a question. Attendees are unable to vote for their own questions.
   1743 displays the number of votes a question has received.
   1744 displays the question and its respective information e.g. when and where this question was asked.
   1745 displays the different DialogLoop options available to the logged-in user. For example, the logged-in user can link multiple social media accounts in “Manage My Account”, configure DialogLoop, create their attendee profile, and download their reports and much more.
FIG. 16 shows an attendee profile card.
   1750 shows one example of how one attendee can initiate a conversation with one or more attendees in a DialogLoop Session based on the rules set by the administrator, the presenter, event organizer and others. When permitted, DLPS is able to make a connection even if the attendee's don't have the contact information of the other attendees. DLPS enables new networking options before, during and after the presentation.
   1751 shows one example of how an attendee can promote themselves at an event by sharing their social media information. In this way, attendees can learn more about each other.
   1752 and 1753 show one example of how attendee profile card information is displayed to other attendees. The information and layout can be configured by each attendee.
The clients may store user preferences, notes and other information in local databases and/or in the DialogLoop cloud storage depending on the situation. In one example, the attendee can specify their individual objectives.
Proprietary and 3^{rd} party algorithms make recommendations on who an attendee should be meeting at the event in order to help their individual objectives.
Semi-anonymous mode—A user may sign into the service with their social media credentials and then choose to be semi-anonymous during an event or presentation. In this case, only their initials (for example, BL for Bob Loblaw) and generic image will be shown to other attendees. The attendee can change this preference at any time. The presenters/moderators/administrators may have access to the real identity of the attendee.

One or more processors may be included in a central processor unit (CPU) of a computer server acting to perform any of the above-described functionality. A plurality of “processors” may be utilized as it is common for a CPU of a computer server to have multiple processors (sometimes also referred to as cores); however, it is to be understood that a single processor may also be configured to perform the described functionality in other implementations.

Although the invention has been described in connection with preferred embodiments, it should be understood that various modifications, additions and alterations may be made to the invention by one skilled in the art without departing from the spirit and scope of the invention.

The modules may be implemented by software executed by one or more processors operating pursuant to instructions stored on a tangible computer-readable medium such as a storage device to perform the above-described functions. Examples of the tangible computer-readable medium include optical media (e.g., CD-ROM, DVD discs), magnetic media (e.g., hard drives, diskettes), and other electronically readable media such as flash storage devices and memory devices (e.g., RAM, ROM). The computer-readable medium may be local to the computer executing the instructions, or may be remote to this computer such as when coupled to the computer via a computer network such as the Internet. The processors may be included in a general-purpose or specific-purpose computer that becomes the access controller or any of the above-described modules as a result of executing the instructions.

In other embodiments, rather than being software modules executed by one or more processors, the modules and any of the above functionality may be implemented as hardware modules configured to perform the above-described functions. Examples of hardware modules include combinations of logic gates, integrated circuits, field programmable gate arrays, and application specific integrated circuits, and other analog and digital circuit designs.

Functions of single modules may be separated into multiple units, or the functions of multiple modules may be combined into a single unit.

Unless otherwise specified, features described may be implemented in hardware or software according to different design requirements. In addition to a dedicated physical computing device, the word “server” may also mean a service daemon on a single computer, virtual computer, or shared physical computer or computers, for example. All combinations and permutations of the above described features and embodiments may be utilized in conjunction with the invention.

What is claimed is:

1. A presentation system comprising:
a first user device being operated by a presenter of a presentation;
a second user device being operated by an attendee of the presentation; and
one or more computer servers coupled to the first user device and the second user device via a computer network;
wherein the first user device is operable to render a plurality of slides of the presentation into a web readable file format and transmit the slides in the web readable file format to the one or more computer servers via the computer network;
the first user device is further operable to start the presentation and send a message informing the one or more computer servers of a current slide of the presentation;
the one or more computer servers are operable to receive the slides in the web readable file format from the first user device and transmit at least the current slide in the web readable file format to the second user device via the computer network;
the one or more computer servers are further operable to send substantially in real-time a current slide identifier message to the second user device, the current slide identifier message identifying when the presenter has changed to the current slide during the presentation; and
the second user device is operable to display the current slide in response to receiving the current slide identifier message identifying the current slide.

2. The presentation system of claim 1, wherein the second user device is further operable to allow the attendee to view any previously displayed slide but prevents the attendee from viewing any slides of the presentation that have not yet been identified as the current slide during the presentation.

3. The presentation system of claim 2, wherein the slides of the presentation are ordered and the second user device is further operable to allow the attendee to view any slides that are prior to the current slide but prevents the attendee from viewing any slides of the presentation that are after the current slide.

4. The presentation system of claim 2, wherein one or more slides that are viewable by the attendee on the second user device change over time as the current slide changes during the presentation.

5. The presentation system of claim 1, wherein:
the one or more computer servers are further operable to generate a presentation identifier and send the presentation identifier to the first user device;
the first user device is further operable to play an audio representation of the presentation identifier from a speaker; and
the second user device is further operable to detected the audio representation of the presentation identifier utilizing a microphone and to send a message to the one or more computer servers to join the presentation identified by the presentation identifier via the computer network.

6. The presentation system of claim 1, further comprising:
a beacon speaker positioned within a physical area proximate to the second user device;
wherein the one or more computer servers are further operable to generate a presentation identifier and send the presentation identifier to the beacon speaker;
the beacon speaker is further operable to play an audio representation of the presentation identifier; and
the second user device is further operable to detected the audio representation of the presentation identifier utilizing a microphone and to send a message to the one or more computer servers to join the presentation identified by the presentation identifier via the computer network.

7. The presentation system of claim 1, wherein:
the one or more computer servers are operable to receive a plurality of user feedback from a plurality of additional user devices regarding the current slide;
the one or more computer servers are operable to send the user feedback back to the first user device;
the first user device is operable to update the first slide according to the updated user feedback, render an updated version of the current slide in the web readable file format, and send the updated version of the current slide to the one or more computer servers;
the one or more computer servers are operable to send the updated version of the current slide to the second user device; and
the second user device is operable to display the updated version of the current slide to the attendee.

8. The presentation system of claim 7, wherein:
the user feedback is continuously arriving and the first user device generates a plurality of versions of the current slide as the user feedback arrives over time;
the one or more computer servers send each updated version of the current slide to the second user device; and
the second user device is further operable to display each new version as they arrive such that the attendee can see how the user feedback is changing the current slide substantially in real time during the presentation.

9. The presentation system of claim 8, wherein the current slide is a survey question and the user feedback represents audience answers to the survey question.

10. The presentation system of claim 1, further supporting other presentation resources in addition to the slides.

11. The presentation system of claim 1, wherein:
the one or more computer servers are further operable to record audio from the presenter during the presentation and to track data indicating when each slide of the presentation was displayed during the presentation; and
the one or more computer servers are further operable to send the audio and the data to the second user device thereby allowing the second user device to play the audio that was spoken during the presentation for any of the slides in the presentation.

12. The presentation system of claim 1, wherein:
the second user device is further operable to send social media information regarding the attendee on a particular social media platform to the one or more computer servers via the computer network; and
the one or more computer servers are further operable to correlate and match multiple attendees of the presentation according to the social media information and to send one or more connection recommendations to second user device, the connection recommendations identifying other users that the attendee may wish to connect with on the particular social platform.

13. The presentation system of claim 1, wherein:
the one or more servers are further operable to send to the second user device a translated version of the current slide in a different language than that displayed by the presenter on a display screen during the presentation; and
the second user device is further operable to allow the attendee to view the translated version of the current slide;
whereby the attendee may view the current slide in a preferred language even though the preferred language is different than that utilized on the display screen during the presentation.

14. An apparatus as shown and described herein.

15. A method as shown and described herein.
